(19) United States
(12) Patent Application Publication
(10) Pub. No.: US 2007/0115440 A1
(43) Pub. Date: May 24, 2007

(54) Projection display with screen compensation

(75) Inventor: Christopher A. Wiklof, Everett, WA (US)

Correspondence Address: Microvision, Inc., 19910 North Creek Parkway, Bothell, WA, 98011, US

(73) Assignee: Microvision, Inc.

(21) Appl. No.: 11/284,043

(22) Filed: Nov. 21, 2005

(51) Int. Cl. G03B 21/14

(52) U.S. Cl. 353/69

(57) ABSTRACT

A control system for a projection display includes means for compensating for spatial variations or artifacts in light scattered by a projection screen. According to embodiments, a sensor produces a signal corresponding to the amount of light scattered to a viewer on a region-by-region or pixel-by-pixel basis. A screen map is created from the sensor signal. Input display data is convolved with the screen map to produce a compensated display signal. The compensated display signal drives a projection display engine. The projected light driven by the compensated display signal convolves with the display screen to produce a viewable image having reduced artifacts. According to one embodiment, a relatively fixed screen map is produced during a calibration routine. According to another embodiment the screen map is updated dynamically during a display session.

### FIELD OF THE INVENTION

The present invention relates to projection displays, and especially to projection display control systems that compensate for imperfections in the displayed image.

### BACKGROUND

In the field of projection displays, a designer may select a display screen or surface that has controlled optical properties. In particular, for a high quality displayed image, one may select a display surface free of marks or other optical inconsistencies that would be visible in the displayed image. The projector-to-screen geometry may also be selected to avoid geometric distortion. Moreover, the design and fabrication of display optics and other components may be controlled to avoid distortion introduced by the projection display.

FIG. 1 is a diagram illustrating in one dimension the operation of a display system showing the interaction of a video signal with a display surface. An input video signal 102 is provided. As illustrated, the vertical axis of input video signal 102 represents a one-dimensional line through a display image. The horizontal axis represents a pixel level or brightness. Thus, input video signal 102 is shown as consisting of interleaved pixels or lines that vary in brightness value. Vertical line 104 represents an assumed or actual display screen response taken along a corresponding line shown on the vertical axis. As may be seen, the display screen response 104 is assumed to have a uniform response—such that here is substantially no variation in the scattering or transmission of light along the line. A transmitted image 106 is shown along a corresponding line in the vertical axis. As may be seen, the input video image 102, when convolved with a uniform screen response 104, creates an output image 106 that is substantially identical with the input video image 102. Thus the viewer 108 sees the video image substantially as it was intended to be seen.

FIG. 2 is another diagram illustrating the operation of a display system made when the display screen includes non-uniformities. A video input 102 is provided as in FIG. 1. This time, however, the screen response 202 is non-uniform. As may be seen, some regions scatter or transmit higher amounts of light toward the viewer 108 and other regions scatter or transmit lower amounts of light toward the viewer. When the video input 102 is convolved with the non-uniform screen response 202, a non-uniform output image 204 results. As may be seen with the exemplary case, the variation in pixel values present in the input video image 102 is superimposed over the screen response 202 to output the non-uniform output image 204. The non-uniform output image 204 is thus perceived by the viewer 108 as a video image that differs at least somewhat from the image that the video input 102 was intended to depict.

Another aspect of variations in image quality delivered to the viewer has to do with a non-ideal geometric relationship between the projector and the screen or between the projector, the screen, and the viewer. An example of such variations corresponds to what is commonly referred to as keystone distortion. In keystone distortion, a screen that is non-normal to the axis of projection will result in image growth in one area relative to another area. Typically, keystone distortion is corrected manually by adjusting a shift lens element to make the edges of the image parallel. In other instances, variations in screen flatness or distance can result in local compression or expansion of pixel placement or variations in image size, respectively.

Another aspect of variations in image quality may not-visible to the viewer but may result in higher cost, lower reliability, or reduced availability of a display system. Variations arise from design limitations that place a burden on optimizing projector design to reduce image distortion. In a related aspect, any “damage” or other variations in the relationship between or behavior of projector components can cause a degradation in performance that may not be compensated for.

### Overview

One aspect according to the invention relates to methods and apparatuses for compensating for imperfections in display screen surfaces.

According to one embodiment, the scattering or projection properties of a selected display screen are measured. A projection display modifies the value of projected pixels in a manner corresponding to the optical properties of the display screen at respective pixel locations. For example, regions that tend to absorb a given wavelength also tend to scatter less of that wavelength to the eye of the viewer, so pixels that correspond to such regions may be modified to provide a higher output of the wavelength to overcome the reduced scattering. Additionally or alternatively, regions that have a higher than average amount of scattering of a given wavelength may receive projected pixels having reduced power in that wavelength. Thus, variations in the way the pixels are scattered or transmitted from the display screen are compensated for and the perceived image quality may be improved.

According to some embodiments, a substantially inverse image of the display screen may be combined with received video data to provide modified video data that is emitted to the display screen. According to other embodiments, received video data may be modified by multiplying input pixel values by the inverse of corresponding screen responses to derive compensated pixel values.

According to some embodiments, the light scattering or transmitting properties of a display screen are measured. The measured properties are used to provide a screen compensation bitmap and the screen compensation bitmap is projected onto the screen along with video program material. According to other embodiments, the measured properties are used to provide a screen compensation convolution table that is convolved with input video program material data to derive compensated video program material data.

According to one embodiment the properties of the display screen are measured during a dedicated calibration process.

According to another embodiment the properties of the display screen are measured substantially continuously.

According to one embodiment, the properties of a rear projection screen are compensated for.

According to another embodiment, the properties of a front projection screen are compensated for. According to some embodiments, the front projection screen may be a purpose-built projection screen. According to other embodiments, the front projection screen may be a wall, a door, window coverings, a bookshelf, or other arbitrary surface that would otherwise be unsuitable for high quality video projection.

According to one embodiment the projection display comprises a scanned beam display or other display that sequentially forms pixels.

According to another embodiment the projection display comprises a focal plane display such as a liquid crystal display (LCD), micromirror array display, liquid crystal on silicon (LCOS) display, or other display that substantially simultaneously forms pixels.

According to one embodiment, a focal plane detector such as a CCD or CMOS detector is used as a screen property detector to detect screen properties.

According to another embodiment, a non-imaging detector such as a photodiode including a positive-intrinsic-negative (PIN) photodiode, phototransistor, photomultiplier tube (PMT) or other non-imaging detector is used as a screen property detector to detect screen properties. According to some embodiments, a field of view of a non-imaging detector may be scanned across the display field of view to determine positional information.

According to one embodiment, the projection display comprises a screen property detector. According to another embodiment the screen property detector is provided as a piece of calibration equipment.

According to one embodiment screen calibration is performed automatically. According to another embodiment screen calibration is performed semi-automatically or manually.

According to some embodiments, compensation data may provide for projecting relatively high quality images onto surfaces of relatively low quality, such as an ordinary wall. This may be especially useful in conjunction with portable computer projection displays, such as “beamers”.

According to another aspect, a displayed image monitoring system may sense the relative locations of projected pixels. The relative locations of the projected pixels may then be used to adjust the displayed image to project a more optimum distribution of pixels. According to one embodiment, optimization of the projected location of pixels may be performed during a calibration period. According to another embodiment, optimization of the projected location of pixels may be performed substantially continuously during a display session.

### BRIEF DESCRIPTION OF THE DRAWINGS

FIG. 1 is a diagram illustrating the operation of a display system made according to the prior art.

FIG. 2 is another diagram illustrating the operation of a display system made according to the prior art when the display screen includes non-uniformities.

FIG. 3 is a diagram illustrating a uniform video signal interacting with a non-uniform screen response according to an embodiment.

FIG. 4 is a flow chart showing a method for generating a screen compensation pattern according to an embodiment.

FIG. 5 is a simplified diagram illustrating a sequential process for projecting pixels and measuring a screen response according to an embodiment.

FIG. 6 is a flow chart representing a method for sequentially measuring a screen response according to an embodiment.

FIG. 7 is a diagram illustrating a calibrated system illuminating a screen with non-uniform response to produce a flat field response according to an embodiment.

FIG. 8 is a block diagram of a scanned-beam type projection display with a capability to compensate for variations in screen properties according to an embodiment.

FIG. 9 is a block diagram of an apparatus and method for generating a compensation pattern for a display screen according to an embodiment.

FIG. 10 is a diagram illustrating an initial state prior to determining a display surface response.

FIG. 11 is a diagram illustrating a state where a display surface response has been fully converged according to an embodiment.

FIG. 12 is a diagram illustrating a display surface response that has been converged to a partially compensating state according to an embodiment.

FIG. 13 is a flow chart showing a method for converging on a screen compensation pixel value according to an embodiment.

FIG. 14 is a diagram illustrating the combination of an input video signal and a screen response to form a compensated output video signal according to an embodiment.

FIG. 15 is a diagram illustrating the interaction of a compensated video pattern with a screen response to produce a perceived projected image according to an embodiment.

FIG. 16 is a flow chart illustrating a method for determining a compensated video image according to an embodiment.

FIG. 17 is a diagram illustrating dynamic updating of a screen compensation map according to an embodiment.

FIG. 18 is a block diagram illustrating the relationship of major components of a screen-compensating display system according to an embodiment.

FIG. 19 is a block diagram illustrating the relationship of major components of a screen-compensating display controller according to an embodiment.

FIG. 20 is a perspective drawing of a detector subsystem according to an embodiment.

FIG. 21 is a perspective drawing of a front projection display with screen compensation according to an embodiment.

FIG. 22 is a perspective drawing of an exemplary portable projection system with screen compensation according to an embodiment.

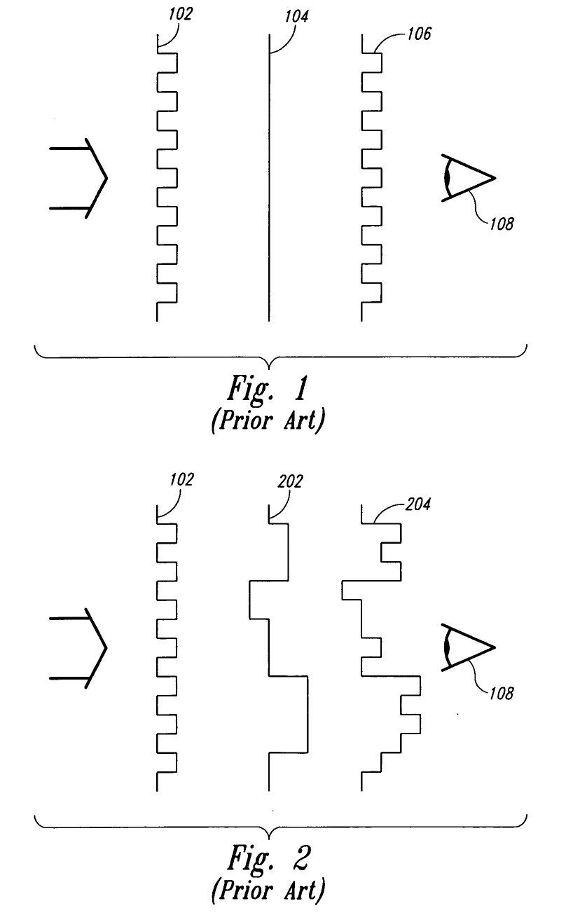

### DETAILED DESCRIPTION

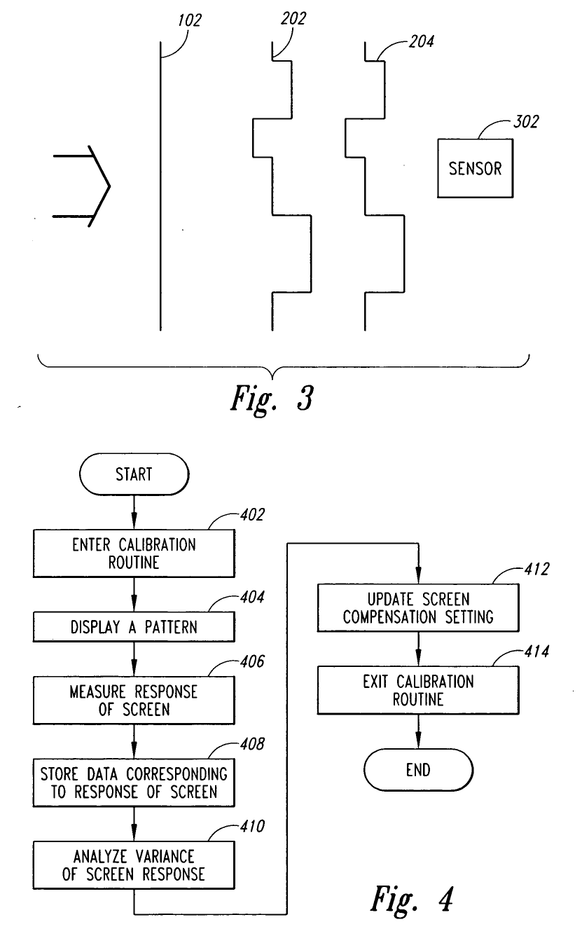

FIG. 3 is a diagram illustrating a uniform video signal 102 interacting with a non-uniform screen response 202 to produce a non-uniform output video s signal 204 having features corresponding to the features of the non-uniform screen response, according to an embodiment. A sensor 302 is aligned to receive at least a portion of a signal corresponding to the output video signal 204. According to one embodiment, the sensor 302 may be a focal plane detector such as a CCD array, CMOS array, or other technology such as a scanned photodiode, for example. The sensor 302 detects variations in the response signal 204 produced by the interaction of the input video signal 102 and the screen response 202. While the screen response 202 may not be known directly, it may be inferred by the measured output video signal 204. It may also be noted that in some applications the output video signal may be affected by other aspects of the projection system including a video signal transmission path, optics, electronics, and other aspects not directly attributable to the screen response 202. As will be appreciated, embodiments allow the measurements made by the sensor 302 to compensate not only for non-uniform screen response, but also for other system non-uniformities. Furthermore, as will be appreciated; the system may detect and compensate for variations arising from geometric relationships such as a non-ideal geometric relationship between a projection system and screen; variations in screen flatness; a geometric relationship between a projection system, screen and viewer; etc. Thus, strictly speaking, the output video signal 204 includes not only variations arising from the screen response 202, but also variations arising from other system components.

Although there may be differences between the response signal 204 and the actual screen response 202, hereinafter they may be referred to synonymously for purposes of simplification and ease of understanding.

FIG. 4 is a flow chart comprising a method for generating a screen compensation pattern, according to an embodiment. In step 402, a controller enters a calibration routine. The calibration routine may, for example, be executed at start-up or wake-up of the display, be executed at shut down or between receipt of program signals, be executed upon selection by the viewer, be executed at installation of a projection display system, or alternatively may be executed substantially continuously during operation of the display system. Accordingly, step 402 may be initiated manually or automatically, depending upon the particular application.

Proceeding to step 404, a known pattern is projected onto a display surface. The known pattern may be, for example, uniform or varied, static or dynamic, a special calibration pattern or normal programming. These and other approaches may be used in accordance with embodiments, according to designer or user preferences.

Proceeding to step 406, a sensor assembly such as a focal plane optical sensor is used to measure the image scattered by the display surface or screen. One way for doing this is to simply take one or a series of digital pictures of the displayed pattern. Alternatively, a pattern may be sequentially provided. The use of a sequentially presented calibration pattern will be described more fully below.

The measured response of the screen may, for instance, include uniform or local variations in the optical scattering efficiency in one or more projected wavelengths. Alternatively or additionally; the measured response of the screen may include variations in pixel placement; such as when a projected image includes keystone, barrel, pincushion or other “uniform” optical distortions; or when a projected image includes local distortions arising from non-idealities or damage to the optical or other subsystems of the projection system; or when a projected image includes local distortions arising from screen flatness errors; for example.

Proceeding to step 408, the image, an inverted version of the image, a pixel placement distortion model or map, or other data that is characteristic of the measured image from the screen is stored. Some focal plane imagers store a captured image locally so it will be appreciated that step 408 may or may not be a discrete step, according to the particular embodiment.

In step 410, the measured response of the screen is compared to the input data pattern. For example, if one area of a projection surface includes a region that is painted red, then the measured value of pixels in the region may be higher in the red channel and lower in green and blue channels, the latter being absorbed by the paint rather than scattered. One way to compensate for such a painted region may, for example, be to somewhat reduce the level of pixel red values and somewhat increase the level of pixel green and blue values in the region. The amount of reduction or increase in each channel will depend upon the comparison of the measured pattern to the known input pattern.

Similarly, geometric variations in pixel placement, or required offsets in pixel placement relative to the input pattern may be stored as a compensation setting.

Proceeding to step 412, the calculated increase and/or decrease of pixel levels in each channel are stored as an updated compensation setting.

According to some embodiments, the screen compensation settings are stored as a bitmap corresponding to an inverted image of the projection screen. This allows a fairly simple addition or multiplication of input video pixel values with the corresponding screen compensation pixel values. Thus, areas that are relatively dark may receive higher value (brighter) projected pixels and/or areas that are relatively light may receive lower value (dimmer) projected pixels.

According to other embodiments, screen compensation settings may be stored as values in a screen compensation matrix. During projection, the input bitmap may be convolved with the screen compensation matrix to produce an output bitmap. According to the value of the coefficients in the screen compensation matrix, pixel brightness and pixel placement may be modified according to the nature of the measured image distortion. Additionally or alternatively, at least a portion of the screen compensation settings may be stored in other forms. For example, correction of keystone, pincushion, or barrel distortion may be stored as a projection lens shift value, algorithmic coefficients, etc., while pixel brightness compensation and/or local pixel placement compensation is stored as coefficients in the screen compensation matrix.

Furthermore, while the flowchart of FIG. 4 is shown as a discrete calibration routine, calibration may be developed iteratively, continuously, etc. For example, where compensation for pixel placement results in displacement of pixels to locations outside the former, distorted display field of view, a second iteration may be used to determine pixel brightness values within such previously unmeasured regions. Continuous or iterative calibration can be made using rules that vary according to measured displacement from nominal. Such rules can result in fast convergence from large displacements (such as in location or brightness) and then shift to low control gain convergence at small displacements to improve stability of the convergence routine.

After storing the updated screen compensation values, the program proceeds to step 414, wherein the calibration routine is exited. Especially for systems that perform continuous or semi-continuous screen compensation updates, steps 402 and 414 may be omitted and the program simply loop back to step 404 and the process repeated.

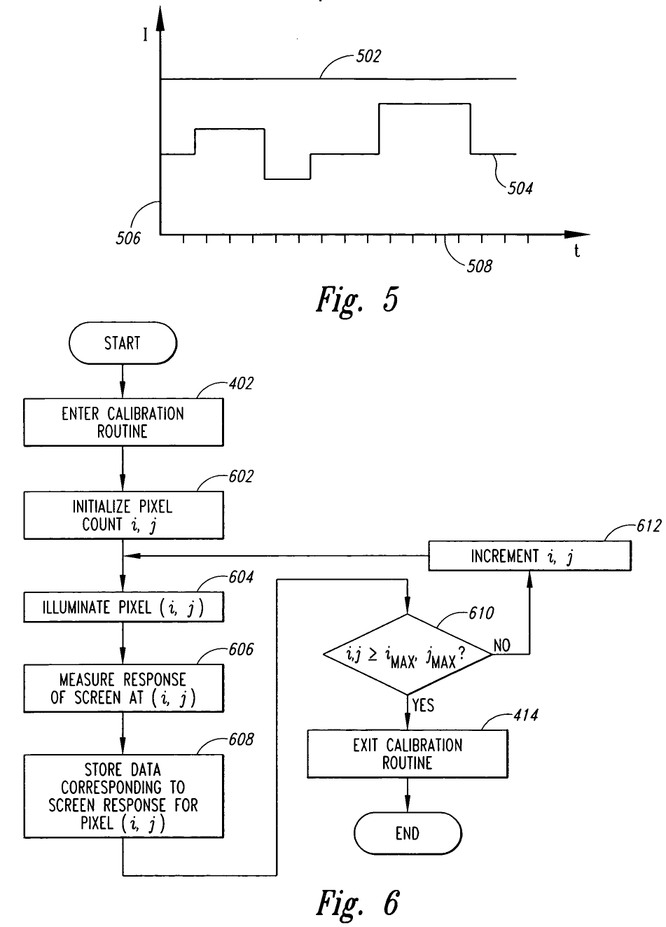

FIG. 5 is a simplified diagram illustrating a process for sequentially projecting pixels and measuring screen response or simultaneously projecting pixels and sequentially measuring screen response, according to embodiments. Sequential video projection and screen response values 502 and 504, respectively, are shown as intensities I on a power axis 506 vs. time shown on a time axis 508. Tic marks on the time axis represent periods during which a given pixel is displayed with an output power level 502. At the end of a pixel period, a next pixel, which may for example be a neighboring pixel, is illuminated. In this way, the screen is sequentially scanned, either with a pixel light intensity shown by curve 502 or by the detected light intensity value 504. Thus, it can be seen that in the example of FIG. 5 the pixels each receive uniform illumination as indicated by the flat illumination power curve 502. Alternatively, values may be varied and the varied values used for comparison to the measured values.

As may be seen from the measured screen response curve 504, the screen includes non-uniformities that cause a variable light scattering.

One advantage of sequential measurement of screen response, as shown in FIG. 5, is that a non-imaging detector may be more easily used.

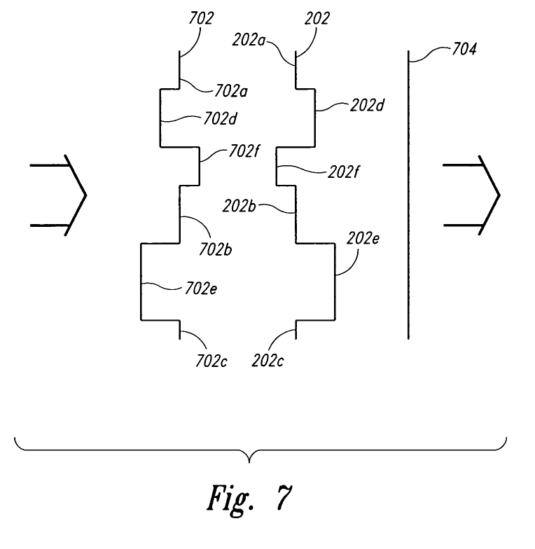

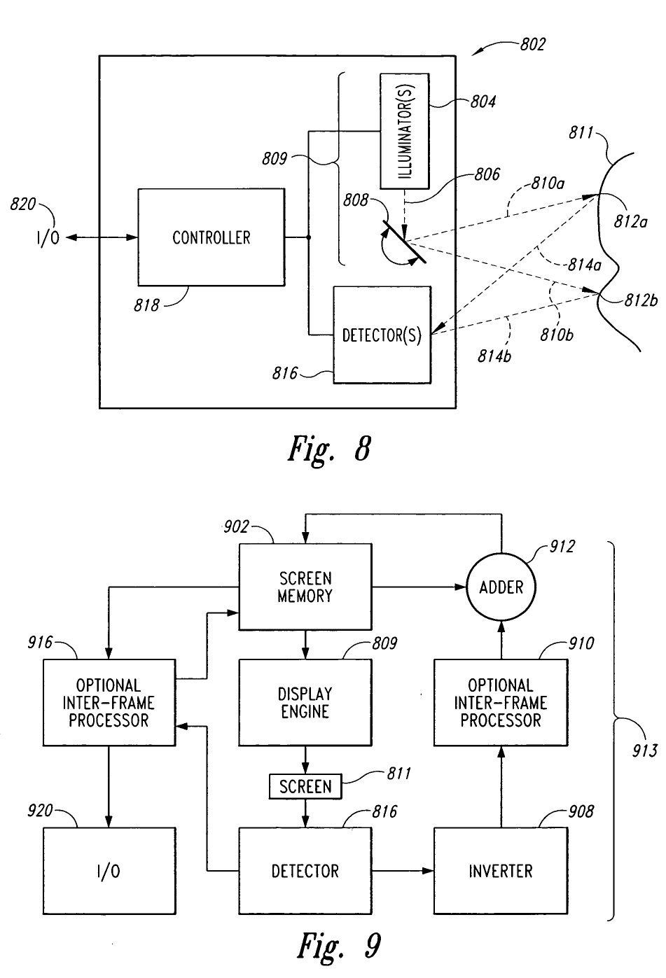

FIG. 6 is a flow chart representing a method for sequentially measuring a screen response, according to an embodiment. In step 402, the program enters a calibration process. Proceeding to step 602, a pixel count is initialized to a starting pixel. The starting pixel may be selected as a particular pixel, for example such as the topmost, leftmost pixel (1,1), it may be selected as a result of a previously measured anomaly in screen response, it may be randomized to produce a varying calibration pattern, or other conventions may be used. For the present example, it is assumed that the pixel count is initialized to i=1, j=1, where i is the column and j is the row.

The program then proceeds to step 604 where the currently selected pixel is illuminated on the projection screen. Such illumination may be at constant level as indicated in FIG. 5, or may alternatively be varied from pixel to pixel. Similarly, the pixel may be illuminated with one color, such as red, green, or blue for example; or alternatively may be simultaneously illuminated with plural colors, for example with an RGB signal nominally intended to produce a white-balanced spot. The choice of how to illuminate a pixel may depend upon the particular application and upon the hardware implementation. For example, for applications where a non wavelength-differentiating detector such as an unfiltered PIN photodiode or unfiltered focal plane detector array is used, it may be advantageous to sequentially project individual colors to unambiguously determine the response of the screen to individual colors. For applications where RGB filtered detectors are used, it may be advantageous to project red, green, and blue channels simultaneously to reduce calibration time.

Proceeding to step 606 the amount of light scattered off the screen (or in the case of a rear projection screen, transmitted by the screen) at the i,j pixel is detected and measured. As with the flow chart of FIG. 6, a number of technologies may be used to detect the screen response. According to one exemplary embodiment, one filtered PIN photodiode is used for each color channel, for example a red filtered PIN photodiode, a green filtered PIN photodiode, and a blue filtered PIN photodiode. The responses of the photodiodes may be normalized for sensitivity in hardware, for example by selecting amplifier gain, or alternatively compensation for sensitivity may be made in software.

The particular methods for sequentially detecting pixel values in the combination of steps 604 and 606 may vary according to hardware implementation and/or other design consideration. For example, as indicated above an illuminated pixel may be scanned to select a location for measuring the screen response. A non-imaging detector having a field of view corresponding to possible pixel positions may then be used to measure screen response. To select the next pixel, the illuminated pixel may then be incremented with the non-imaging detector continuing to monitor its field of view. Pixel scanning may comprise modifying a light propagation path, for example as in a scanned beam projection display, or alternatively may comprise selecting a new pixel from a matrix of pixels, for example as in an LCOS, LCD, DMD, or other parallel illumination display technology. Alternatively, a detector field-of-view may be set to a small area, for example corresponding to a single pixel, and the detector scanned across a larger display field of view. In the case of scanning the detector, it may be advantageous to illuminate a number of pixels simultaneously. Alternatively, combinations of pixel scanning and detector scanning may be used.

As an alternative to measuring the screen response for single pixels, a plurality of pixels may be measured simultaneously using the method of FIGS. 5 and 6. For example, using a non-imaging detector with a field of view substantially equal to the entire display field, pairs, triplets, etc. of pixels may be illuminated. Sequences of pixels illuminated may be selected such that the confounding of individual pixel responses may be canceled over time by statistically evaluating the measured responses. A similar approach can be used to reduce or eliminate confounding arising from measuring plural pixel responses measured by a scanned detector or simultaneously scanned pixels and a scanned detector. According to another embodiment, plural detectors may be used, the individual detectors having fields of view less than the entire display field. In this way, four detectors, each having a detectable field of view approximately equal to one-quarter of the display field can be used while four pixels, one in each field, is projected and its response measured. Pixels near the intersections between detectors may be illuminated singly to remove the confounding of being measured by plural detectors simultaneously.

According to another embodiment, detectors may be selected to have small fields of view corresponding to desired angles to the four corners of a display field. Pixels may be illuminated and/or the projection path varied until an appropriate response is received by the four detectors. By offsetting the incidence angle of the pixel source from the detector, a trapezoid may be deduced that is indicative of a correction for keystone compensation. By solving the trigonometry for the baseline between the pixel source and the detector, real keystone correction may be deduced from the apparent angles to the corners of the display.

A similar approach to offsetting the incidence angle from the detection angle may be used with an imaging detector such as a focal plane detector to determine geometric variations in screen response, for example such as keystone correction, pincushion/barrel distortion correction, etc.

Returning to FIG. 6, in step 608 the screen response is stored in memory. As in other embodiments, a number of conventions may be used to indicate screen response. According to one embodiment, an average screen response for all pixels and all color channels is saved. Individual pixel variations are then saved as a code value returned by a sensor analog-to-digital converter above or below the average response. According to another embodiment, the negative value of the individual response is saved, the latter approach allowing simple addition of pixel code values or scaled code values. As used herein, addition or subtraction of code values will be simplified as equivalent as it is understood that addition of a negative value is the same as subtraction of the same positive magnitude. According to another embodiment, the response of an individual pixel is saved as a multiple or divisor compared to the average pixel response. In one approach, the response is stored as a coefficient in a screen compensation matrix or a portion of the response may be stored as a coefficient in a screen compensation matrix, as described above in conjunction with FIG. 4.

According to another embodiment, screen response is saved as offsets from input pixel values, such as in a LUT. The offsets are allowed to vary as a function of input pixel value. Such an approach allows the processor to accommodate video rate input data by using relatively simple addition/subtraction functions, while the data in the LUT corresponds to a multiplicative relationship between the screen response and the value of the input pixel data. According to still another embodiment, the LUT size may be reduced by saving offsets according to a range of input pixel values, thus providing a trade-off between memory size and the precision of screen compensation, while still allowing for a stepwise multiplicative relationship between input pixel value and screen compensation offset.

Proceeding to step 610, a check is made to see if the last pixel has been measured. This may be the actual last pixel in the entire field of view, or alternatively may be another pixel in a range of pixels chosen for calibration. If the last pixel has been measured, the program proceeds to step 414 where the calibration routine is exited. As an alternative, the pixel value may be incremented again to the first pixel value and the process of steps 604-608 repeated. Such an approach allows for continuous calibration. If the last pixel has not been measured, the program proceeds to step 612 where the pixel value is incremented to the next pixel value and the process of steps 604-608 are repeated.

FIG. 7 is a diagram illustrating a calibrated system illuminating a screen non-uniformly, with the screen having a corresponding non-uniform response to produce a flat field response, according to an embodiment. In FIG. 7, a system or alignment of a projection display was determined to produce a screen response 202. From the previously determined screen response, a screen compensation pattern 702 is determined for an illumination level. When a compensated illumination pattern 702 is shown on or through the projection screen having the screen response 202, the result is a flat field response 704. As may be seen from inspection of FIG. 7, areas of the screen that scatter or transmit a nominal amount of illumination 202a, 202b, and 202c receive a corresponding nominal amount of illumination energy 702a, 702b, and 702c, respectively. Areas of the screen that scatter or transmit a greater amount of illumination 202d and 202e receive a corresponding reduced amount of illumination energy 702d, and 702e, respectively, the amount of which is scaled according to the screen response. Areas such as 202f that scatter or transmit higher than average amounts of illumination energy toward the viewer receive corresponding reduced amounts of illumination energy 702f. The amount of increase or reduction in illumination energy is made such that the quantity of illumination is balanced by the quantity of scatter or transmission to provide a uniform response 704 that may be visible to the viewer.

Of course, the relative amount of illumination increase or decrease called for to fully compensate for the non-uniform screen response may fall outside the dynamic range of the projection display. In such cases, a variety of approaches may be used to best approximate ideal compensation. For example, according to one embodiment when a “dark” feature is found to lie in the left side of the display screen and a “light” feature is found to lie on the right side of the display screen, pixel compensation may be selected to vary the viewed image brightness smoothly across the display screen so as to reduce the visual conspicuousness of the features. According to another embodiment, the system may be used to attenuate the visibility of undesirable features on the display screen, even if the edges of the feature are still faintly visible. According to another embodiment, the overall brightness of the display may be decreased or increased to substantially keep the required pixel brightness within the dynamic range of the display engine. According to another embodiment, the dynamic range of the displayed image may be reduced. User preferences may be accommodated to select between or balance between compensation logic. For example, a user selected “brightness” that is set higher than available dynamic range would indicate may be used to select relatively less screen compensation. As the user gradually reduces the brightness, more and more screen compensation may be invoked as the dynamic range of the projection engine allows.

FIG. 8 is a block diagram of an exemplary projection display apparatus 802 with a capability for displaying an image on a surface 811 having imperfections, according to an embodiment. An input video signal, received through interface 820 drives a controller 818. The controller 818, in turn, sequentially drives an illuminator 804 to a brightness corresponding to pixel values in the input video signal while the controller 818 simultaneously drives a scanner 808 to sequentially scan the emitted light. The illuminator 804 creates a first beam of light 806. The illuminator 804 may, for example, comprise red, green, and blue modulated lasers combined using a combiner optic and beam shaped with a beam shaping optical element. A scanner 808 deflects the first beam of light across a field-of-view (FOV) to produce a second scanned beam of light 810. Taken together, the illuminator 804 and scanner 808 comprise a scanned beam display engine 809. Instantaneous positions of scanned beam of light 810 may be designated as 810a, 810b, etc. The scanned beam of light 810 sequentially illuminates spots 812 in the FOV, the FOV comprising a display surface or projection screen 811. Spots 812a and 812b on the projection screen are illuminated by the scanned beam 810 at positions 810a and 810b, respectively. To display an image, substantially all the spots on the projection screen are sequentially illuminated, nominally with an amount of power proportional to the brightness of an input video image pixel corresponding to each spot.

While the beam 810 illuminates the spots, a portion of the illuminating light beam is reflected or scattered as scattered energy 814 according to the properties of the object or material at the locations of the spots. A portion of the scattered light energy 814 travels to one or more detectors 816 that receive the light and produce electrical signals corresponding to the amount of light energy received. The detectors 816 transmit a signal proportional to the amount of received light energy to the controller 818.

According to alternative embodiments, the one or more detectors 816 and/or the controller 818 are selected to produce and/or process signals from a representative sampling of spots. Screen compensation values for intervening spots may be determined by interpolation between sampled spots. Neighboring sampled values having large differences may be indicative of an edge lying therebetween. The location of such edges may be determined by selecting pairs or larger groups of neighboring spots between which there are relatively large differences, and sampling other spots in between to find the location of edges representing features of interest. The locations of edges on the display screen may similarly be tracked using image processing techniques.

The light source 804 may include multiple emitters such as, for instance, light emitting diodes (LEDs), lasers, thermal sources, arc sources, fluorescent sources, gas discharge sources, or other types of illuminators. In a preferred embodiment, illuminator 804 comprises a red laser diode having a wavelength of approximately 635 to 670 nanometers (nm). In another preferred embodiment, illuminator 804 comprises three lasers; a red diode laser, a green diode-pumped solid state (DPSS) laser, and a blue DPSS laser at approximately 635 nm, 532 nm, and 473 nm, respectively. While some lasers may be directly modulated, other lasers, such as DPSS lasers for example, may require external modulation such as an acousto-optic modulator (AOM) for instance. In the case where an external modulator is used, it is considered part of light source 804. Light source 804 may include, in the case of multiple emitters, beam combining optics to combine some or all of the emitters into a single beam. Light source 804 may also include beam-shaping optics such as one or more collimating lenses and/or apertures. Additionally, while the wavelengths described in the previous embodiments have been in the optically visible range, other wavelengths may be within the scope of the invention.

Light beam 806, while illustrated as a single beam, may comprise a plurality of beams converging on a single scanner 808 or onto separate scanners 808.

Scanner 808 may be formed using many known technologies such as, for instance, a rotating mirrored polygon, a mirror on a voice-coil as is used in miniature bar code scanners such as used in the Symbol Technologies SE 900 scan engine, a mirror affixed to a high speed motor or a mirror on a bimorph beam as described in U.S. Pat. No. 4,387,297 entitled PORTABLE LASER SCANNING SYSTEM AND SCANNING METHODS, an in-line or “axial” gyrating, or “axial” scan element such as is described by U.S. Pat. No. 6,390,370 entitled LIGHT BEAM SCANNING PEN, SCAN MODULE FOR THE DEVICE AND METHOD OF UTILIZATION, a non-powered scanning assembly such as is described in U.S. patent application Ser. No. 10/007,784, SCANNER AND METHOD FOR SWEEPING A BEAM ACROSS A TARGET, commonly assigned herewith, a MEMS scanner, or other type. All of the patents and applications referenced in this paragraph are hereby incorporated by reference

A MEMS scanner may be of a type described in U.S. Pat. No. 6,140,979, entitled SCANNED DISPLAY WITH PINCH, TIMING, AND DISTORTION CORRECTION; U.S. Pat. No. 6,245,590, entitled FREQUENCY TUNABLE RESONANT SCANNER AND METHOD OF MAKING; U.S. Pat. No. 6,285,489, entitled FREQUENCY TUNABLE RESONANT SCANNER WITH AUXILIARY ARMS; U.S. Pat. No. 6,331,909, entitled FREQUENCY TUNABLE RESONANT SCANNER; U.S. Pat. No. 6,362,912, entitled SCANNED IMAGING APPARATUS WITH SWITCHED FEEDS; U.S. Pat. No. 6,384,406, entitled ACTIVE TUNING OF A TORSIONAL RESONANT STRUCTURE; U.S. Pat. No. 6,433,907, entitled SCANNED DISPLAY WITH PLURALITY OF SCANNING ASSEMBLIES; U.S. Pat. No. 6,512,622, entitled ACTIVE TUNING OF A TORSIONAL RESONANT STRUCTURE; U.S. Pat. No. 6,515,278, entitled FREQUENCY TUNABLE RESONANT SCANNER AND METHOD OF MAKING; U.S. Pat. No. 6,515,781, entitled SCANNED IMAGING APPARATUS WITH SWITCHED FEEDS; U.S. Pat. No. 6,525,310, entitled FREQUENCY TUNABLE RESONANT SCANNER; and/or U.S. patent application Ser. No. 10/984,327, entitled MEMS DEVICE HAVING SIMPLIFIED DRIVE; for example; all hereby incorporated by reference.

In the case of a 1D scanner, the scanner is driven to scan output beam 810 along a single axis and a second scanner is driven to scan the output beam 810 in a second axis. In such a system, both scanners are referred to as scanner 808. In the case of a 2D scanner, scanner 808 is driven to scan output beam 810 along a plurality of axes so as to sequentially illuminate pixels 812 on the projection screen 811.

For compact and/or portable display systems 802, a MEMS scanner is often preferred, owning to the high frequency, durability, repeatability, and/or energy efficiency of such devices. A bulk micro-machined or surface micro-machined silicone MEMS scanner may be prefered for some applications depending upon the particular performance, environment or configuration. Other embodiments may be preferred for other applications.

A 2D MEMS scanner 808 scans one or more light beams at high speed in a pattern that covers an entire projection screen or a selected region of a projection screen within a frame period. A typical frame rate may be 60 Hz, for example. Often, it is advantageous to run one or both scan axes resonantly. In one embodiment, one axis is run resonantly at about 19 KHz while the other axis is run non-resonantly in a sawtooth pattern to create a progressive scan pattern. A progressively scanned bi-directional approach with a single beam, scanning horizontally at scan frequency of approximately 19 KHz and scanning vertically in sawtooth pattern at 60 Hz can approximate an SVGA resolution. In one such system, the horizontal scan motion is driven electrostatically and vertical scan motion is driven magnetically. Alternatively, both the horizontal scan may be driven magnetically or capacatively. Electrostatic driving may include electrostatic plates, comb drives or similar approaches. In various embodiments, both axes may be driven sinusoidally or resonantly.

Several types of detectors 816 may be appropriate, depending upon the application or configuration. For example, in one embodiment, the detector may include a PIN Photodiode connected to an amplifier and digitizer. In this configuration, beam position information is retrieved from the scanner or, alternatively, from optical mechanisms. In the case of multi-color imaging, the detector 816 may comprise splitting and filtering to separate the scattered light into its component parts prior to detection. As alternatives to PIN photodiodes, avalanche photodiodes (APDs) or photomultiplier tubes (PMTs) may be preferred for certain applications, particularly low light applications.

In various approaches, photodetectors such as PIN photodiodes, APDs, and PMTs may be arranged to stare at the entire projection screen, state at a portion of the projection screen, collect light retro-collectively, or collect light confocally, depending upon the application. In some embodiments, the photodetector 816 collects light through filters to eliminate much of the ambient light.

The projection display 802 may be embodied as monochrome, as full-color, or hyper-spectral. In some embodiments, it may also be desirable to add color channels between the conventional RGB channels used for many color displays. Herein, the term grayscale and related discussion shall be understood to refer to each of these embodiments as well as other methods or applications within the scope of the invention. In the control apparatus and methods described below, pixel gray levels may comprise a single value in the case of a monochrome system, or may comprise an RGB triad or greater in the case of color or hyperspectral channels (for instance red, green, and blue channels) or may be applied universally to all channels, for instance as luminance modulation.

FIG. 9 is a block diagram of a feedback apparatus for determination of screen response according to an embodiment. The block diagram of FIG. 9 is able, for example, to generate a compensated illumination pattern 702 shown in FIG. 7. Initially, a drive circuit drives the light source based upon a pattern, which may be embodied as digital data values in screen memory 902. The screen memory 902 drives display engine 809 during calibration. Display engine 809 may for instance comprise an illuminator 804 and scanner 808 as FIG. 8. The display engine projects pixels onto a display surface 811. For each spot or region of display surface, an amount of scattered light is detected and converted into an electrical signal by detector 816. Detector 816 may include an A/D converter that outputs the electrical signal add a binary value, for instance. The detected signal is inverted by inverter 908, and is optionally processed by optional intra-frame image processor 910. The inverted detected signal or processed value is then added to the corresponding value in the screen memory 902 by adder 912. This proceeds through the entire frame or projection screen until substantially all spots have been scanned and their corresponding screen memory values modified. The process is then repeated for a second frame, a third frame, etc. until substantially all spots have converged to a common amount of scattered light. In some embodiments and particularly those represented by FIG. 11 below, the converged pattern in the screen memory represents the inverse of the projection screen response, akin to the way a photographic negative represents the inverse of its corresponding real-world image.

Inventer 908, optional intra-frame processor 910, and adder 912 comprise leveling circuit 913.

The pattern in the screen memory 902 may be read out and 9 may be subjected to optional inter-frame image processing by optional inter-frame image processor 916. The pattern in the screen memory 902 or the processed value in screen memory may be output to a video source or host system via interface 920.

Optional intra-frame image processor 910 includes line and frame-based processing functions to manipulate and override the control input of the detector 816 and inverter 908 outputs. For instance, the processor 910 can set feedback gain and offset to adapt numerically dissimilar illuminator controls and detector outputs, can set gain to eliminate or limit diverging tendencies of the system, and can also act to accelerate convergence and extend system sensitivity. As was described above, the logic for converging the screen memory may vary according to the degree of divergence a given pixel has with respect to a nominal value. To ease understanding, it will be assumed herein that detector and illuminator control values are numerically similar, that is one level of detector grayscale difference is equal to one level of illuminator output difference.

As a result of the convergence of the apparatus of FIG. 9, spots that scatter a small amount of signal back to the detector become illuminated by a relatively high beam power while spots that scatter a large amount of signal back to the detector become illuminated with relatively low beam power. Upon convergence, the overall light energy received at from each spot may be substantially equal.

One cause of differences in apparent brightness is the light absorbance properties of the material being illuminated. Another cause of such differences is variation in distance from the detector. Optionally, time-of-flight or other distance measurement apparatus and methods may be used to correct for variations in screen compensation that arise due to differences in distance. In many applications it is desirable to project an image onto a relatively flat or smoothly curved surface having no or only moderately varying distance from the detector 816. In such applications, it may be unnecessary to measure projection surface distance.

According to an embodiment, the controller may be programmed to ignore changes in received scattered energy that vary slowly according to position, instead determining compensation values only for regions having relatively sharp transitions in screen response. Such a system may, for example provide screen compensation values sufficient to overcome variations in screen response relative to a local value of a low slope variation in response.

Optional intra-frame image processor 910 and/or optional inter-frame image processor 916 may cooperate to ensure compliance with a desired safety classification or other brightness limits. This may be implemented for instance by system logic or hardware that limits the sum total energy value for any localized group of spots corresponding to a range of pixel illumination values in the screen memory. Further logic may enable greater illumination power of previously power-limited pixels during subsequent frames. In fact, the system may selectively enable certain pixels to illuminate with greater power (for a limited period of time) than would otherwise be allowable given the safety classification of a device.

While the components of the apparatus of FIG. 9 are shown as discrete objects, their functions may be split or combined as appropriate for the application. In particular, inverter 908, intra-frame processor 910, adder 912, and inter-frame processor 916 may be integrated in a number of appropriate configurations

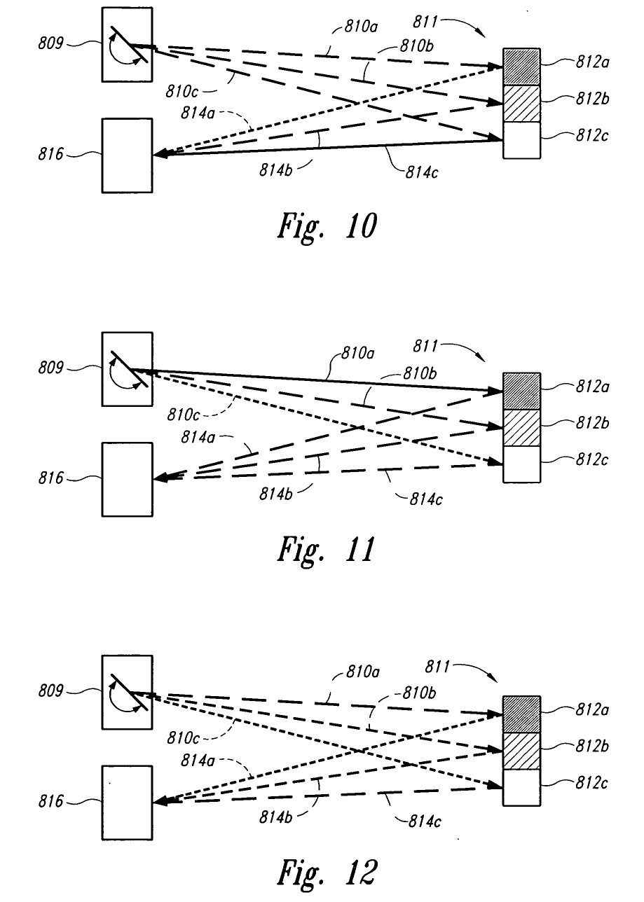

The effect of embodiments corresponding to the apparatus of FIGS. 8 and 9 may be more effectively visualized by referring to FIGS. 10 and 11. FIG. 10 illustrates a state corresponding to an exemplary initial state of screen memory 902. A beam of light 810 produced by a display engine 809 is shown in three positions 810a, 810b, and 810c, each illuminating three corresponding spots 812a, 812b, and 812c, respectively. Spot 812a is shown having a relatively low scattering or transmission. In this discussion, relative scattering or transmission will be referred to as apparent brightness. Spot 812b has a medium apparent brightness and spot 812c has a relatively high apparent brightness. These are indicated by the dark gray, medium gray and light gray shading of spots 812a, 812b, and 812c, respectively.

In an initial state corresponding to FIG. 10, the illuminating beam 810 may, for example, be powered at a medium energy at all locations, illustrated by the medium dashed lines impinging upon spots 812a, 812b, and 812c. In this case, dark spot 812a, medium spot 812b, and light spot 812c return low strength scattered signal 814a, medium strength scattered signal 814b, and high strength scattered signal 814c, respectively to detector 816. Low strength scattered signal 814a is indicated by the small dashed line, medium strength scattered signal 814b is indicated by the medium dashed line, and high strength scattered signal 814c is indicated by the solid line.

FIG. 11 illustrates a case where the screen memory 902 has been converged to a flat-field response, according to an embodiment. After such convergence, light beam 810 produced by display engine 809 is powered at level inverse to the apparent brightness of each spot 812 it impinges upon. In particular, dark spot 812a is illuminated with a relatively powerful illuminating beam 810a, resulting in medium strength scattered signal 814a being returned to detector 816.

Medium spot 812b is illuminated with medium power illuminating beam 810b, resulting in medium strength scattered signal 814b being returned to detector 816.

Light spot 812c is illuminated with relatively low power illuminating beam 810c, resulting in medium strength scattered signal 814c being returned to detector 816. In the case of FIG. 11, the screen memory has been converged such that the scanned beam compensation signals make the screen appear to be a substantially white-balanced region of uniform brightness.

It is possible and in some cases preferable not to fully converge the screen memory such that all spots on the projection screen return substantially the same energy to the detector. For example, it may be preferable to compress the returned signals somewhat to preserve the relative strengths of the scattered signals, but move them up or down as needed to fall within a reasonable range of neighboring spots so as to “smear out” abrupt transitions on the projection screen. FIG. 12 illustrates this variant of operation. In this case, the illumination beam 810 is modulated in intensity by display engine 809. Beam position 810 a is increased in power somewhat in order to raise the power of scattered signal 814a to fall above the detection floor of detector 816 but still result in scattered signal 814a remaining below the strength of other signals 814b scattered by neighboring spots 812b having higher apparent brightness. The detection floor may correspond for example to quantum efficiency limits, photon shot noise limits, electrical noise limits, or other selected limits. Conversely, apparently bright spot 812c is illuminated with the beam at position 810c, decreased in power somewhat in order to lower the power of scattered signal 814c to fall below the detection ceiling of detector 816, but still remain higher in strength than other scattered signals 814b returned from neighboring spots 812b with lower apparent brightness. The detection ceiling of detector 816 may be related for instance to full well capacity for integrating detectors such as CCD or CMOS arrays, non-linear portions of A/D converters associated with non-pixelated detectors such as PIN diodes, or other selected limits set by the designer. Of course, illuminating beam powers corresponding to other spots having scattered signals that do fall within detector limits may be similarly modified in linear or non-linear manners depending upon the requirements of the application. For instance, in some applications, the apparent brightness range of spots may be compressed to fit the dynamic range of the detector, spots far from a mean level receiving a lot of compensation and spots near the mean receiving only a little compensation. Alternatively, compensation power may be determined as a maximum slope from neighboring pixels, thus producing an image with smoothly varying background features on an otherwise optically noisy projection screen.

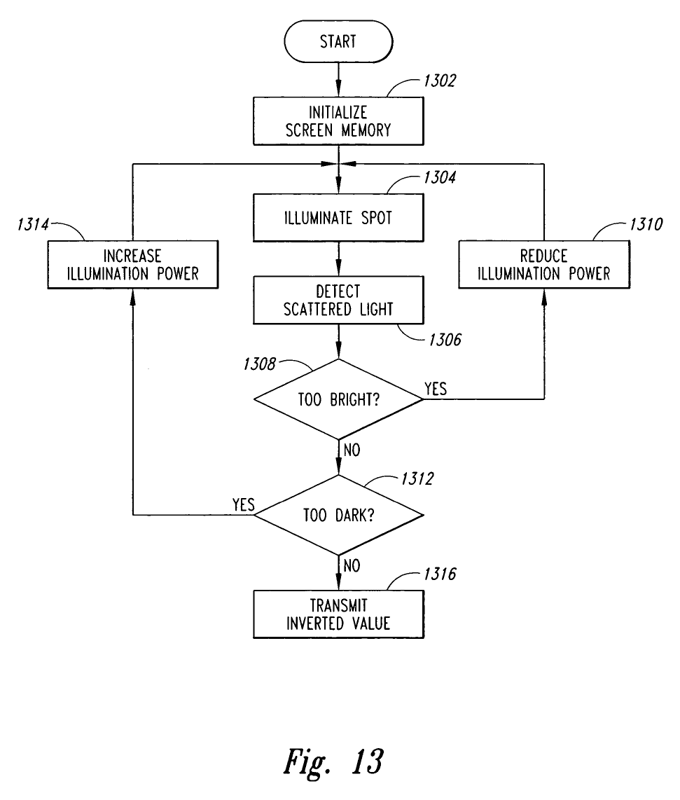

FIG. 13 is a flow chart showing a method according to an embodiment for converging a pixel value to level appropriate for screen compensation. In step 1302, the screen memory is initialized. In some embodiments, the buffer values may be set to fixed initial values near the middle, lower end, or upper end of the power range. Alternatively, the buffer may be set to a quasi-random pattern designed to test a range of values. In yet other embodiments, the buffer values may be informed by previous pixels in the current frame. In still other embodiments, the buffer values may be informed by previous frames or previous images.

Using the initial screen memory value, a spot is illuminated and its scattered light detected as per steps 1304 and 1306, respectively. If the detected signal is too strong per decision step 1308, illumination power is reduced per step 1310 and the process repeated starting with steps 1304 and 1306. If the detected signal is not too strong, it is tested to see if it is too low per step 1312. If it is too low, illuminator power is adjusted upward per step 1314 and the process repeated starting with steps 1304 and 1306.

Thresholds for steps 1308 and 1312 may be set in many ways. For example, some or all of the pixels on the projection surface may be illuminated with an output power near the center of the power range of the light source(s), the amount of scattered energy received measured, and the measured values averaged. The average screen response measured by the detector, optionally plus and minus a small amount for steps 1308 and 1312, respectively, may then be used as thresholds. Alternatively, output power may be varied to fall within the dynamic range of the detector. For detectors that are integrating, such as a CCD detector for instance, illuminator powers with corresponding thresholds that return scattered pixel energies above noise equivalent power (NEP) (corresponding to photon shot noise or electronic shot noise, for example) and below full well capacity may be used. Instantaneous detectors such as photodiodes may be limited by non-linear response at the upper end and limited by NEP at the lower end. Thus these points may be used to select illuminator powers for steps 1308 and 1312, respectively. Alternatively, upper and lower thresholds may be programmable depending upon video image attributes, application, user preferences, illumination power range, electrical power saving mode, etc. In some embodiments, thresholds are set according to the response of neighboring pixels, with values chosen such that changes in image brightness, white balance, etc. are allowed over moderate distances. Such an approach can result in the ability to use projection screens that would otherwise have scattering or transmission responses that exceed the dynamic range of the illuminators.

Thus, upper and lower thresholds used by steps 1308 and 1312 may be variable across the projection screen.

After a scattered signal has been received that falls into the allowable detector range, the detector value may be transmitted for further processing, storage, etc. in optional step 1316.

After convergence, screen memory values may be combined with the incoming video image to level the screen response and provide an image superior to what might be otherwise formed on a given projection surface.

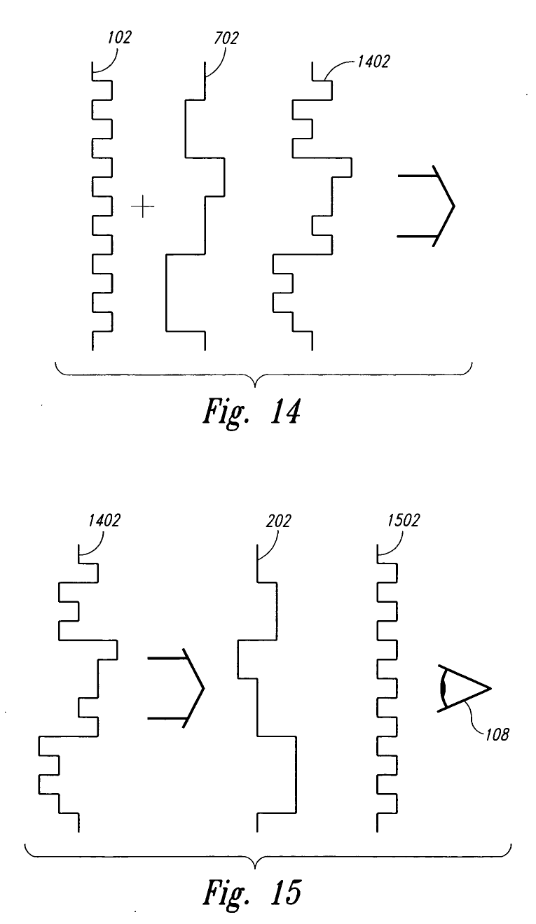

FIG. 14 is a diagram that shows the combination of an input video pattern 102 with a screen compensation pattern 702 to form a compensated video pattern 1402 according to an embodiment. FIG. 15 is a diagram illustrating the interaction of a compensated video pattern 1402 with a screen response 202 to produce a projected image 1502 as perceived by a viewer 108.

According to an embodiment, the screen compensation pattern 702 may be combined with the video pattern 102 through addition or subtraction, depending upon the screen compensation format, to form a compensated video pattern 1402. Such an approach may be especially useful when the affect of screen variable response on the perceivable image is small. That is, variations of a few bits in screen response across the dynamic range of the light sources may be compensated quite efficiently by addition or subtraction of screen compensation offset values to create a compensated video pattern. Such addition or subtraction may be provided in ranges. For example a greater amount may be added or subtracted at high power levels and a corresponding lesser amount added or subtracted at low power levels. Such greater or lesser addition or subtraction values (screen compensation offset values) may be determined algorithmically, for example. Alternatively, screen compensation offset values may be determined by measuring screen response across a range of illumination powers.

According to another embodiment, the screen compensation pattern 702 may be combined with the video pattern 102 through multiplication or division operations. For example, for pixel locations corresponding to a region on the projection screen that scatters only half the amount of green light required for proper white balance or alternatively only have the amount of green light as the average screen response, the green code value in the input video signal may be doubled (multiplied by decimal 2).

According to another embodiment, compensated video signal pixel values may be determined according to a look-up table (LUT) that is constructed according to screen calibration results. In such a LUT, screen compensation may be gradually decreased at extremes of code values to accommodate dynamic range limitations of the projection display engine. According to another embodiment, the compensated video signal pixel values may be determined by convolving the input video bitmap with a screen compensation matrix.

According to another embodiment, compensated video pixel values may be calculated algorithmically.

As may be seen by inspection of FIGS. 14 and 15, application of screen compensation to an input video signal 102 may result in a perceivable image 1502 that substantially matches the input video image. Alternatively, the compensated video image 1402 may be formed such that the perceivable image 1502 includes fewer screen artifacts than would be present if the input video image 102 was projected.

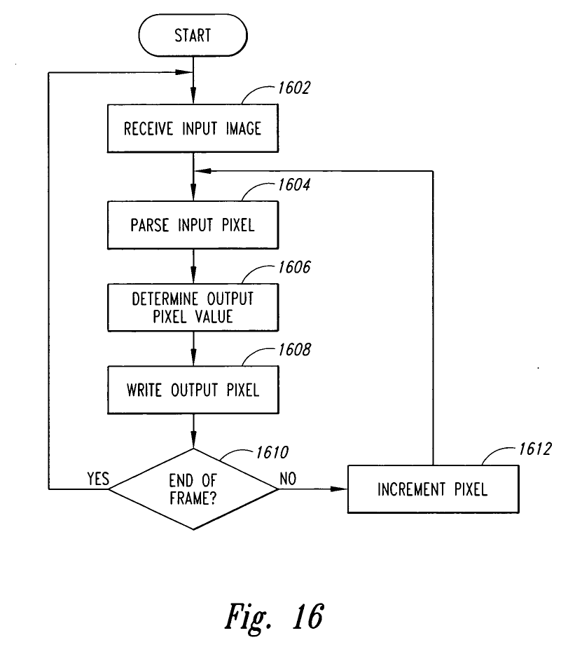

FIG. 16 is a flow chart illustrating a method for generating a compensated video image according to an embodiment. Starting the process at step 1602, an input video image is received. How this is done, depends upon the embodiment and the application. For example, an image may be received from a computer across a conventional wired or wireless interface as a bitmapped image. Alternatively, the control process of FIG. 16 may be resident in the image source computer and receiving the input image may comprise reading a display memory. Alternatively, the input image may be received as a video image from a DVD player, VCR, television tuner, or the like as an NTSC, PAL, HDTV, etc. compliant signal. Alternatively, the process of step 16 may be included within a DVD player, VCR, television tuner, or the like. In any case, step 1602 may include converting the image into a format appropriate for modification, for example as a bitmapped image. For illustration purposes, it will be assumed herein that the input image is finally received as a bitmap for display.

Proceeding to step 1604, the process parses through the image to select input pixels and/or channels for possible modification. For example, the process may start with the upper leftmost pixel (e.g. pixel 1,1) and proceed across columns then down rows until the bottom rightmost pixel (e.g. pixel 800,600 for an SVGA image) is processed.

Proceeding to step 1606, the process determines output pixel values for each input pixel value and corresponding screen response for the pixel. According to one embodiment, this is done by accessing a LUT. Other embodiments may use algorithmic determination of the output pixel value in conjunction with a screen map.

For example, a screen map value is read for the current pixel. According to one embodiment, the screen map value is stored as an inverted value, such as in the screen map stored in the screen compensation memory 902 of FIG. 9. The inverted value is added to the current pixel to derive at least an intermediate value. Thus, spots with high scattering or transmission of a given wavelength channel are stored as relatively small values in the screen map and only a small amount is added to the input pixel value. Conversely, spots with low scattering or transmission of a given wavelength are stored as relatively large values and the input pixel is added to such relatively large values to create extra gain for spots that are not efficient at displaying the wavelength. Following derivation of the at least intermediate value, another uniform value, such as the average response, for example, may optionally be subtracted from the intermediate value to derive the output pixel value.

According to another embodiment, the screen map values are stored as a multiplier for each spot. Such a multiplier may be derived, for example, by dividing the converged spot code value by the code value of the illumination power used during calibration. During step 1604, the multiplier for a spot corresponding to a pixel is read from the screen map and multiplied with the input pixel value to derive an output pixel value. Optionally, an offset may then be added or subtracted from each spot to maximize dynamic range. Alternatively, spots with large multipliers (corresponding to poor scattering or transmission of a given color) may be allowed to reach a maximum value and the image displayed with the best possible compensation, realizing that certain spots may be too inefficient to properly reach the desired apparent brightness, given a maximum power output of the display engine. The addend may additionally be determined through user input whereby a user “dials in” a larger added value for a brighter image or a smaller (perhaps negative) added value for a dimmer image.

Proceeding to step 1608, the derived output pixel value is written to an output buffer for driving the display engine. If the current pixel is not the last pixel in a video frame, step 160 directs the program to step 1612, which increments the pixel value and then returns to step 1604 where the next pixel is parsed and the output pixel derivation procedure is repeated. If the current pixel is the last pixel in the frame, step 1610 directs the program to step 1602 where a next video frame is read and the whole process repeated.

As may be readily appreciated, the process of FIG. 16 may occur on a number of different hardware embodiments including but not limited to a programmable microprocessor, a gate array, an FPGA, an ASIC, a DSP, discrete hardware, or combinations thereof. The process of FIG. 16 may further be embedded in a system that executes additional functions or may be spread across a plurality of subsystems.

The process of FIG. 16 may operate with monochrome data or with a plurality of wavelength channels, each channel having, for example, individual coefficients or addends for each spot in the screen map.

The process of FIG. 16 may operate on RGB values. Alternatively, the process may operate using chrominance/luminance or other color descriptor systems.

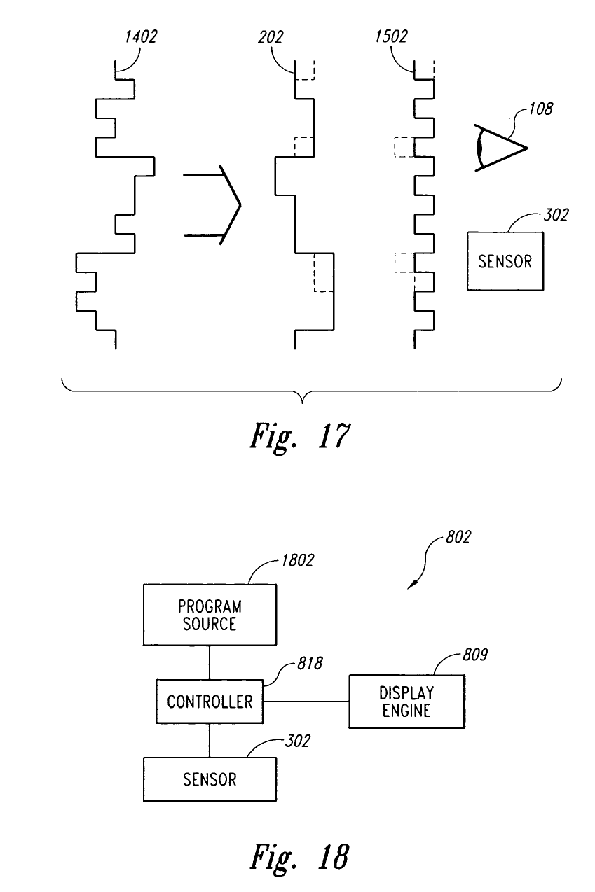

In addition to discrete or separate screen calibration and display functions, systems may dynamically monitor the scattering or transmission of the display screen and update the screen map. FIG. 17 is a diagram illustrating dynamic updating of a screen compensation map. A compensated video signal 1402 interacts with a screen response 202 to provide a compensated visible image 1502 to a viewer 108 while a sensor 302 simultaneously monitors the image output 1502 of the system. For cases where the screen response remains 202 static, illustrated by the solid lines in the screen response 202, the displayed image 1502 will remain properly compensated, illustrated by the solid lines in the displayed image 1502. However, in some cases, the screen response may change. Normal screen aging, soiling, and damage may be the cause of changes. Another cause for change has to do with the display engine moving relative to the projection surface or screen, such as in a hand-held projection display.

In cases where there are changes in the screen response 202, indicated by dashed lines in the screen response 202, corresponding variations in the displayed image 1502 may result, indicated by dashed lines in the displayed image 1502.

The sensor 302 may continuously monitor the output image 1502, comparing it to the input video image (not shown) and determine pixels that do not match the desired output indicated by the solid line. In such a case, the sensor measures the variance in apparent brightness. The calibration system, which may for example be embodied as the process of FIG. 6, receives the measured value and updates the screen compensation map to accommodate the variations in response. Compensated output signals for subsequent video frames will thus be based on the updated screen map. The process of continuous monitoring and update may operate substantially continuously, upon user triggering, at pre-determined intervals, or according to other schedules as may be appropriate for an application.

FIG. 18 is a block diagram illustrating the relationship of major components of an embodiment of a screen-compensating display system 802. Program source 1802 provides a signal to controller 818 indicative of content to be displayed. Controller 818 drives display engine 809 to display the content onto a display screen (not shown). Sensor 302 receives light scattered or transmitted by the display screen and provides a signal to the controller 818 indicative of the strength of the received signal. The components operate together in a manner described elsewhere herein. The display engine may be of a number of different types. Although a scanned beam display engine is described in detail above, other display engine technologies such as LCD, LCOS, mirror arrays, CRT, etc. may be used in conjunction with the screen compensation system described herein.

The major components shown in FIG. 18 may be distributed among a number of physical devices in various ways or may be integrated into a single device. For example, the controller 818, display engine 809, and sensor 302 may be integrated into a housing capable of coupling to a separate program source 1802 through a wired or wireless connector. According to another example, the program source may be a part of a larger system, for example an automobile sensor and gauge system, and the controller, display engine, and sensor integrated as portions of a heads-up-display. In such a system, the controller 818 may perform data manipulation and formatting to create the displayed image.

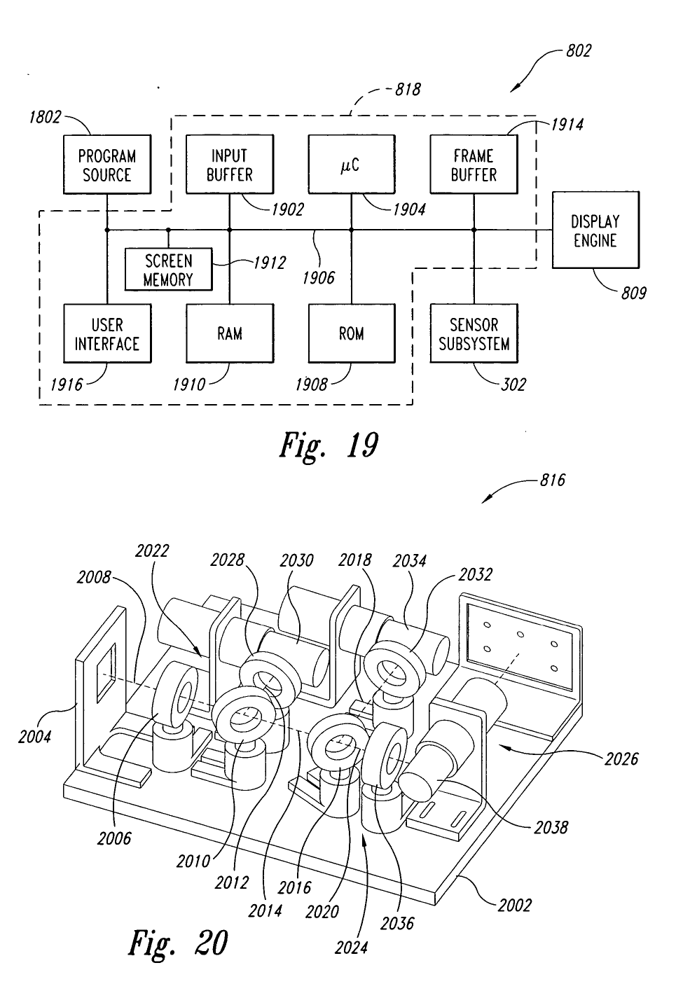

FIG. 19 is a block diagram, according to an embodiment, illustrating the relationship of major components of a screen-compensating display controller 818 and peripheral devices including the program source 1802, display engine 809, and sensor subsystem 302 used to form a screen-compensating display system 802. The embodiment of FIG. 19 is a fairly conventional programmable microprocessor-based system where successive video frames are received from the video source 1802 and saved in an input buffer 1902 by a microcontroller 1904 operating over a conventional bus 1906. The microcontroller operates instructions read from read-only memory 1908 to read pixel values from the input buffer 1902 into a random access memory 1910, read corresponding portions of the screen memory 1912, and perform operations to derive compensated pixel values, which are written into an output frame buffer 1914. The contents of the output frame buffer 1914 are transmitted to the display engine 809, which contains digital-to-analog converters, output amplifiers, light sources, one or more pixel modulators (such as a beam scanner, for example), and appropriate optics to display an image on a screen (not shown). The sensor subsystem 302 measures the amount of light scattered or transmitted by the screen and the values returned from the sensor subsystem 302 are used by the microcontroller 1904 to construct or update a screen map, as described above. A user interface 1916 receives user commands that, among other things, affect the properties of the displayed image. Examples of user control include compensation override, compensation gain, brightness, pixel range truncation, on-off, enter-calibration, continuous calibration on/off, etc.

FIG. 20 is a perspective drawing of a detector module 816 made according to an embodiment. Within detector module 816, the scattered light signal is separated into its wavelength components, for instance RGB.

Optical base 2002 is a mechanical component to which optical components are mounted and kept in alignment. Additionally, base 2002 provides mechanical robustness and, optionally, heat sinking. The sampled scattered or transmitted light enters the detector 816 through a window 2004 with further light transmission is made via the free space optics depicted in FIG. 20. Focusing lens 2006 shapes the received light 2008 that propagates through the window 2004. Mirror 2010, which may be a dielectric mirror, splits off a blue light beam 2012 and directs it to the blue detector assembly. The remaining composite signal 2014, comprising green and red light, is split by dielectric mirror 2016. Dielectric mirror 2016 directs green light 2018 toward the green detector assembly, leaving red light 2020 to pass through to the red detector assembly.

Blue, green, and red detector assemblies 2022, 2024, and 2026, respectively, each comprise an appropriate wavelength filter and a detector. The type of detectors used in the embodiment of FIG. 20 are photomultiplier tubes (PMTs). Specifically, the blue detector assembly comprises a blue filter 2028 and a PMT 2030 for detecting blue light; the green detector assembly comprises a green filter 2032 and a PMT 2034 for detecting green light; and the blue detector assembly comprises a red filter 2036 and a PMT 2038 for detecting red light. The filters serve to further isolate the detector from any crosstalk, which may be present in the form of light of unwanted wavelengths. For one embodiment, HAMMAMATSU model R1527 PMT may give satisfactory results for each of the three channels. This tube has an internal gain of approximately 10,000,000, a response time of 2.2 nanoseconds, a side-viewing active area of 8×24 millimeters, and a quantum efficiency of 0.1. Other commercially available PMTs may be satisfactory as well.

For the PMT embodiment of the detector 816, two stages of amplification, each providing approximately 15 dB of gain for 30 dB total gain, boost the signals to levels appropriate for analog-to-digital conversion. The amount of gain varies slightly by channel (ranging from 30.6 dB of gain for the red channel to 31.2 dB of gain for the blue channel), but this is not felt to be particularly critical because calibration and subsequent processing can maintain white balance.

In another embodiment, avalanche photodiodes (APDs) are used in place of PMTs. The APDs used include a thermo-electric (TE) cooler, TE cooler controller, and a transimpedence amplifier. The output signal is fed through another 5× gain using a standard low noise amplifier.

As was indicated above, alternative non-imaging light detectors such as PIN photodiodes may be used in place of PMT or APD type detectors. Additionally, detector types may be mixed according to application requirements. Also, it is possible to use a number of channels fewer than the number of output channels. For example a single detector may be used. In such a case, an unfiltered detector may be used in conjunction with sequential illumination of individual color channel components of the pixels on the display surface. For example, red, then green, then blue light may illuminate a pixel with the detector response synchronized to the instantaneous color channel output. Alternatively, a detector or detectors may be used to monitor a luminance signal and screen compensation dealt with through variable luminance gain. In such a case, it may be useful to use a green filter in conjunction with the detector, green being the color channel most associated with the luminance response. Alternatively, no filter may be used and the overall amount of scattering or transmission by the display surface monitored.

As may be appreciated, a non-imaging detector system such as that shown in FIG. 20 may be used in a variety of implementations, including those where pixels are generally displayed simultaneously. In one example, a pixel at a time is progressively displayed during a calibration routine. The response of the screen to each pixel is used to determine the screen map. Various acceleration approaches such as an analysis of variance where multiple pixels are displayed simultaneously may be used. Pixel locations may additional be scanned according to previously measured pixels to measure locations most likely to have display surface non-uniformities.

Non-imaging detectors may additionally be used to perform continuous calibration with simultaneous pixel display engines such as LCD, LCOS, etc. According to one embodiment, a sequence of pixels are displayed across the display surface during successive inter-frame periods, i.e. during periods that are normally blanked. One way to do this is to sequentially latch pixels to the value displayed during the previous period or alternatively to offset the period for display into the inter-frame period.

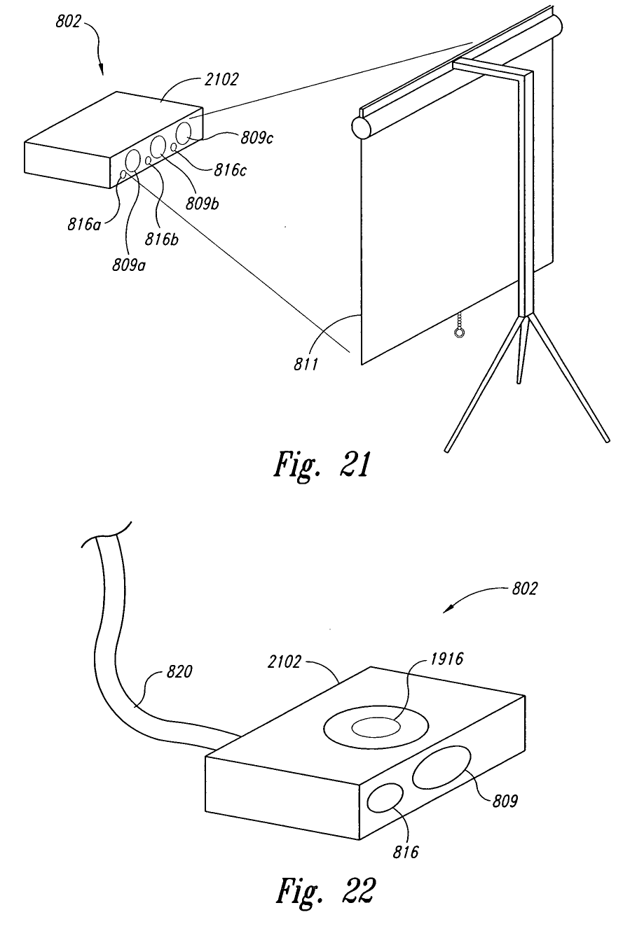

FIG. 21 is a perspective drawing of an exemplary front projection display with screen compensation 802, according to an embodiment. Housing 2102, which may for example be adapted to be mounted to a ceiling, includes a red pixel display engine 809a (of which one can see the output lens), a green pixel display engine 809b, and a blue pixel display engine 809c aligned to project a registered display image onto a projection surface 811. Display engines 809 may, for example, be LCD, LCOS, binary mirror array (DMD), etc. Corresponding sensors 816a, 816b, and 816c are aligned and operable to receive the corresponding red, green, and blue images projected onto the screen 811. In the example of FIG. 21, the sensors 816 are focal plane CCD or CMOS sensors that image the pixels and measure their apparent brightness. Each respective sensor includes a filter to selectively receive the appropriate color channel. While screen 811 is illustrated as a conventional projection screen, it will be appreciated that embodiments may allow projection onto surfaces with optical characteristics that are less than ideal such as a wall, door, etc.

FIG. 22 is a perspective drawing of an exemplary portable projection system with screen compensation 802, according to an embodiment. Housing 2102 of the display 802 houses a display engine 809, which may for example be a scanned beam display, and a sensor 816 aligned to receive scattered light from a projection surface. Sensor 816 may for example be a non-imaging detector system made as a variant of the sensor system of FIG. 20. The display 802 receives video signals over a cable 820, such as a Firewire, USB, or other conventional display cable. Display 802 transmits detected pixel values up the cable 820 to a host computer. The host computer applies screen compensation to the image prior to sending it to the portable display 802. The housing 2102 may be adapted to being held in the hand of a user for display to a group of viewers. A user input 1916, which may for example comprise a button, a scroll wheel, etc., is placed for access to display control functions by the user.

Thus the display of FIG. 22 is an example of a screen compensating display where the display engine 809, sensor 816, and user interface 1916 are in one housing 2102, and the program source 1802 and controller 818 are in a different housing, the two housings being coupled through an interface 820.

According to some embodiments, the detectors 816a, 816b, and 816c of FIG. 21 are offset from their respective corresponding pixel display sources 809a, 809b, and 809c. Similarly, detector 816 of FIG. 22 is offset from the projection display engine output 809. According to an embodiment, the distance between the respective pixel illumination and pixel detection elements represents a baseline from which geometric distortions may be triangulated using simple trigonometry using certain assumptions about the projection screen, such as the screen being parallel to the normal of the mean projection angle in at least one dimension. Alternatively, pairs, triplets, etc. of detectors may be used to provide additional baseline geometries for triangulation of geometric distortion.

According to embodiments, the screen compensation system taught herein may be adapted to rear-projection displays or front-projection displays.

The preceding overview, brief description of the drawings, and detailed description describe illustrative embodiments according to the present invention in a manner intended to foster ease of understanding by the reader. Other structures, methods, and equivalents may be within the scope of the invention.

Compensation for geometric distortions may be driven in a variety of ways, according to the preferences of the embodiment. For example, scanned beam display engines in particular may be driven with offset pixel timing or interpolated/extrapolated pixel locations to compensate for such distortions. Other types of display engines having fixed pixel relationships may be similarly corrected with projection optics to vary pixel projection angle.

The scope of the invention described herein shall be limited only by the claims.

What is claimed is:

1. A method for compensating for patterns on a display surface in a front-projection display comprising:
A) providing a screen compensation map, including;
projecting a first pixel onto a display surface;
measuring the brightness of the first pixel;
storing the brightness of the first pixel in a screen compensation map; and
repeating the projecting, measuring, and storing until a representative plurality of pixels have been projected, measured, and stored to produce the screen compensation map; and
B) projecting a compensated image onto the display surface, including:
receiving a video image signal comprising pixels;
reading the screen compensation map;
modifying the grayscale values of the pixels in the video image signal according to corresponding values in the screen compensation map to produced a compensated video image signal; and
projecting a compensated video image corresponding to the compensated video image signal onto the display surface.

2. The method for compensating for patterns on a display surface in a front-projection display of claim 1 wherein the representative plurality of pixels comprises substantially all the pixels.

3. The method for compensating for patterns on a display surface in a front-projection display of claim 1 wherein the representative plurality of pixels comprises less than substantially all the pixels and wherein providing the screen compensation map further includes interpolating between projected and measured pixels to provide additional interpolated pixels that, taken together with the projected and measured pixels, comprise substantially all the pixels of the display.

4. The method for compensating for patterns on a display surface in a front-projection display of claim 3 further comprising:
determining pairs of measured pixels between which there are relatively large changes in measured screen response; and
for at least one additional pixel between such pairs of measured pixels, repeating the steps of projecting, measuring, and storing to provide the screen compensation map with a more accurate representation of the projection surface.

5. The method for compensating for patterns on a display surface in a front-projection display of claim 1 wherein the steps of repeating the projecting and measuring of the brightness of a pixel on the display surface are performed serially.

6. The method for compensating for patterns on a display surface in a front-projection display of claim 1 wherein the steps of repeating the projecting and measuring of the brightness of a pixel on the display surface are performed substantially simultaneously.

7. A projection display comprising;
a housing;
a projection display engine disposed in the housing and aligned to an external field of view and operable to project pixels onto the external field of view;
a light sensor carried by the housing and aligned to receive energy from the external field of view and operable to detect at least a portion of light energy projected by the projection display engine and scattered by the external field of view and produce a detection signal corresponding to the received scattered energy; and
an interface coupled to the display engine and the light sensor operable to receive from an image source a signal corresponding to an image for display by the projection display engine and further operable to transmit to the image source the detection signal;
whereby the signal corresponding to the image for display may include compensation for the light scattering characteristics of the external field of view.

8. The projection display of claim 7 wherein the projection display engine comprises a scanned beam projection display engine.

9. The projection display of claim 7 wherein the projection display engine comprises a projection implementation selected from the group consisting of an LCD, an LCOS display, a deformable mirror array display, a CRT display, a field emission display, and a plasma display.

10. The projection display of claim 7 wherein the light sensor comprises a non-imaging light sensor.

11. The projection display of claim 10 wherein the light sensor comprises at least one detector selected from the group consisting of a PIN photodiode, an avalanche photodiode, and a photomultiplier tube.

12. The projection display of claim 7 wherein the light sensor comprises an imaging light sensor.

13. The projection display of claim 12 wherein the light sensor is selected from the group consisting of a Bayer-filtered charged coupled device array, a charge coupled device array, three filtered charge coupled device arrays, a Bayer-filtered complementary metal-oxide semiconductor array, a complementary metal-oxide semiconductor array, and three filtered complementary metal-oxide semiconductor arrays.

14. A projection display comprising;
a housing;
a projection display engine disposed in the housing and aligned to an external field of view and operable to project pixels onto the external field of view;
a light sensor carried by the housing and aligned to receive energy from the external field of view and operable to detect at least a portion of light energy projected by the projection display engine and scattered by the external field of view and produce a detection signal corresponding to the received scattered energy;
an interface coupled to the display engine and operable to receive from an image source a signal corresponding to an image for display by the projection display engine; and
a controller operatively coupled to the interface, the projection display engine, and the light sensor; wherein the controller is operable to modify the received image for display responsive to the detection signal to produce a signal for driving the projection display engine.

15. The projection display of claim 14 wherein the controller comprises a screen memory and wherein the controller is operable to:
drive the projection display engine to project at least one pixel onto the field of view;
receive a signal from the light sensor responsive to light scattered from the at least one projected pixel; and
store at least one compensation value corresponding to the at least one projected pixel in the screen memory.

16. The projection display of claim 15 wherein the controller is operable to receive signals from the light sensor and store compensation values in screen memory during a screen calibration routine.

17. The projection display of claim 15 wherein the controller is operable to receive signals from the light sensor and store compensation values in screen memory substantially during projection of video images by the display engine.

18. A method for projecting an image comprising the steps of:
receiving an input video image;
for a plurality of pixels in the input video image, determining a corresponding screen compensation value; and
transmitting an output video image comprising at least one pixel value modified according to its corresponding screen compensation value to be different than the corresponding pixel value received in the input video image.

19. The method for projecting an image of claim 18 further comprising driving a display engine with the output video image to display a compensated video image.

20. The method for projecting an image of claim 18 wherein receiving an input video image comprises reading an input video image from memory.

21. The method for projecting an image of claim 18 wherein transmitting an output video image comprises writing an output video image to memory.

22. The method for projecting an image of claim 18 wherein determining a corresponding screen compensation value comprises reading the corresponding screen compensation value from memory.

23. The method for projecting an image of claim 18 further comprising calculating a modified pixel value from the corresponding input pixel value and screen compensation value.

24. The method for projecting an image of claim 23 wherein calculating a modified pixel value comprises performing an operation selected from the group consisting of adding, subtracting, multiplying, and dividing.

25. The method for projecting an image of claim 24 wherein performing the operation comprises executing an operation selected from the list consisting of a digital logic function, an analog logic function, and a fuzzy logic function.

26. An apparatus for generating a compensated image comprising:
an image buffer operable to receive an input image signal;
a screen memory operable to hold a screen compensation map; and
an electronic processor operable to read the image buffer and the screen memory, and determine a compensated image signal corresponding to the input image signal and the screen compensation map.

27. The apparatus for generating a compensated image wherein the electronic processor is further operable to write the compensated image signal to a buffer.

28. The apparatus for generating a compensated image of claim 27 further comprising an output buffer operable to receive the compensated image signal written by the electronic processor.

29. The apparatus for generating a compensated image of claim 27 wherein the input buffer is further operable to receive the compensated image signal written by the electronic processor.

30. The apparatus of claim 26 wherein the electronic processor comprises a device selected from the group consisting of a digital integrated circuit, an analog integrated circuit, a mixed-signal integrated circuit, a fuzzy logic circuit, discrete circuitry, a microprocessor, a microcontroller, a gate array, a programmable gate array, a field programmable gate array, an application specific integrated circuit, a custom application specific integrated circuit, a standard cell application specific integrated circuit, a programmable logic device, a programmable array logic device, a generic array logic device, a shared controller, and an optical processor.

31. The apparatus for generating a compensated image of claim 26 further comprising a display engine operable to receive the compensated image signal and display a corresponding compensated image.

32. The apparatus for generating a compensated image of claim 31 further comprising a light sensor operable to receive light scattered from the displayed compensated image and generate a sensor signal corresponding to the received light.

33. The apparatus for generating a compensated image of claim 32 wherein the electronic controller is further operable to receive the sensor signal from the light sensor and responsively generate the screen compensation map.

34. The apparatus for generating a compensated image of claim 26 further comprising a video source operable to generate the input image signal.

35. The apparatus for generating a compensated image of claim 26 further comprising an interface operable to receive the input image signal.

36. A method for displaying an image comprising:
receiving a first signal corresponding to an image for display;
receiving a second signal corresponding to a response characteristic of a screen, the response characteristic including at least one of an image portion displacement and an image portion brightness variation; and
combining the first and second signals to produce a third signal that includes an image signal modified according to the response characteristic.

37. The method of claim 36 further comprising driving a projection engine with the third signal to project a displayed image onto the screen.

38. The method of claim 37 wherein the displayed image includes a reduced artifact corresponding to the characteristic of the screen.

39. The method of claim 38 wherein the artifact comprises brightness non-uniformity.

40. The method of claim 38 wherein the artifact comprises geometric distortion.

41. The method of claim 36 wherein the first signal comprises a video image.

42. The method of claim 36 wherein the first signal comprises a bitmapped image.

43. The method of claim 36 wherein the second signal comprises a bitmapped image.

44. The method of claim 36 wherein combining the first and second signals comprises adding corresponding pixel values to produce summed pixel values.

45. The method of claim 44 wherein combining the first and second signals further comprises scaling the summed pixel values to produce summed and scaled pixel values.

46. The method of claim 36 wherein combining the first and second signals comprises multiplying corresponding pixel values to produce multiplied pixel values.

47. The method of claim 46 wherein combining the first and second signals further comprises scaling the summed pixel values to produce multiplied and scaled pixel values.

48. The method of claim 36 further comprising detecting an image produced by the screen to produce the screen response signal.

49. The method of claim 48 further comprising comparing the detected image to an input video image to produce the screen response signal.

50. The method of claim 48 wherein detecting the image produced by the screen includes measuring the amount of light scattered by the screen across a plurality of screen locations and across a plurality of color channels.

51. The method of claim 48 wherein the detecting is performed during a calibration.

52. The method of claim 48 wherein the detecting is performed a plurality of times.

53. The method of claim 52 wherein the detecting is performed substantially continuously and the third compensated signal includes compensation for screen response variations that occur dynamically.

54. The method of claim 48 wherein the detecting is performed by a calibration device.

55. The method of claim 48 wherein the detecting is performed by a sensor that is integral to a projection display.
